(19) United States
(12) Patent Application Publication
(10) Pub. No.: US 2025/0139916 A1
(43) Pub. Date: May 1, 2025

(54) SYSTEM FOR PROVIDING VIDEO-BASED AUGMENTED REALITY CONTENT

(71) Applicant: KOREA ELECTRONICS TECHNOLOGY INSTITUTE, Seongnam-si (KR)

(72) Inventors: Woo Chool PARK, Incheon (KR); Jun Hwan JANG, Goyang-si (KR); Jin Wook YANG, Uijeongbu-si (KR); Minsu CHOI, Seoul (KR); Junsuk LEE, Seoul (KR); Bonjae KOO, Suwon-si (KR)

(21) Appl. No.: 19/006,916

(22) Filed: Dec. 31, 2024

Related U.S. Application Data
(63) Continuation of application No. PCT/KR2022/017874, filed on Nov. 14, 2022.

(30) Foreign Application Priority Data
Aug. 18, 2022 (KR) 10-2022-0103041

(51) Int. Cl. G06T 19/00; G06T 15/00; H04N 21/414; H04N 21/81

(52) U.S. Cl. CPC G06T 19/006; G06T 15/005; H04N 21/41407; H04N 21/8146

(57) ABSTRACT

Proposed is a system for providing video-based augmented reality content. The system may include a mobile device that transmits an image captured via a camera and IMU data, which is position and orientation information about the camera, and plays back received AR content. The image and the IMU data may be transmitted by being combined into a single image data packet. The system may also include a split rendering server that uses the image and IMU data of the image data packet of the mobile device to render a three-dimensional object, and provides the AR content, which is the rendered result, to the mobile device.

### CROSS-REFERENCE TO RELATED APPLICATIONS

This application is a continuation application, and claims the benefit under 35 U.S.C. § 120 and § 365 of PCT Application No. PCT/KR2022/017874, filed on Nov. 14, 2022, which claims priority to Korean Patent Application No. 10-2022-0103041 filed on Aug. 18, 2022, the contents of each of which are hereby incorporated by reference in their entirety.

### NATIONAL RESEARCH AND DEVELOPMENT PROJECTS FOR SUPPORTING THIS DISCLOSURE

Project Unique Number: 1375027482
Project Number: R2020040076-0003.
Ministry Name: Ministry of Culture, Sports And Tourism
Project Management (Specialized) Agency Name: Korea Creative Content Agency
Research Project Name: Cultural Content Development Support Project
Research Project Technology: Development of AR Streaming 5G Service Technology For Realistic E-Sports Broadcasting
Contribution Rate: 1/1
Project Executing Agency Name: Korea Electronics Technology Institute
Research Period: 2020.07.01˜2022.12.31

### BACKGROUND

### Technical Field

The present disclosure relates to a system for providing video-based augmented reality (AR) content, and more particularly, to a system for providing AR capable of reducing delay factors and preventing a degradation in immersive sensation.

### Description of Related Technology

The present disclosure is filed as a result of a national research and development project, and the information thereof is as follows.

Recently, as devices capable of viewing augmented reality such as smartphones and tablet PCs have become commercialized, various games or learning applications using the augmented reality have been provided.

### SUMMARY

One aspect is a system for providing video-based AR content capable of reducing the delay factors that may occur in communication and data processing.

Another aspect is a system for providing video-based augment reality content of the present disclosure for solving the above-mentioned problems that may include a mobile device configured to transmit an image captured by a camera and an inertial measurement unit (IMU) data corresponding to position and posture information via the camera, the image and the IMU data being transmitted by being combined into a single image data packet, and play back received augmented reality (AR), and a split rendering server configured to render a three-dimensional object using the image and the IMU data of the image data packet of the mobile device, and provide the AR content, which is the rendered result, to the mobile device.

In an embodiment of the present disclosure, the image data packet may be packaged in units of five image frames.

In an embodiment of the present disclosure, the image data packet may be packaged in a packaging format of the ISO/IEC 23000 standard.

In an embodiment of the present disclosure, the image data packet may be transmitted according to an HTTP QUIC protocol.

In an embodiment of the present disclosure, the AR content may include one frame in one image track.

In an embodiment of the present disclosure, the transmitter may include the camera configured to capture the image, an IMU data detector configured to detect the IMU data, a stream processor configured to convert the image and the IMU data into a stream data in accordance with synchronization, and a capturing module configured to split the stream data into five frames and package the image and the IMU data into the single image data packet.

In an embodiment of the present disclosure, the receiver may include an AR content processor configured to play back or store the AR content according to a setting, a play-back configured to play back the AR content, and a memory configured to store the AR content.

he present disclosure has an effect of preventing the occurrence of delay factors according to the communication environment by packaging the image and IMU data into single image and transmitting it when transmitting the image captured by the camera and the IMU data of the mobile device to the server, but restricting the frame of the image packaging and transmitting it.

Further, the present disclosure has an effect of preventing the occurrence of delay factors regardless of the communication environment and the performance of the mobile device by transmitting one frame per track when transmitting the AR content to the mobile device after performing rendering on the split rendering server, thereby enabling immediate decoding on the mobile device.

Therefore, the present disclosure has an effect of preventing the occurrence of delay factors related to the communication environment and the performance of the mobile device, thereby preventing the degradation in immersive sensation due to delay when the user uses the AR content.

### BRIEF DESCRIPTION OF THE DRAWINGS

FIG. 1 is a block diagram of a system for providing video-based AR content according to a preferred embodiment of the present disclosure.

FIG. 2 is a detailed block diagram of a mobile device.

### DETAILED DESCRIPTION

Currently, most augmented reality contents are streamed or downloaded and played back using the device's resource, and playback of the contents may be delayed due to various reasons such as device's performance, resource, and streaming environment.

Due to the delay caused by various reasons, the user who experience the augmented reality content may feel a loss of immersion and may become dissatisfied with the system for providing augmented reality content.

In addition, as another system for providing the content, Korean Patent Laid-Open Publication No 10-2022-0058169 (a cloud for rendering AR content and an operating method thereof, published on May 9, 2022) discloses a rendering device and method using a cloud, which, when a device requests playback, plays back a 3D object content in the cloud, acquires sensing information of the device, adjusts a virtual camera position in a 3D space, and renders an AR video based on the position of the virtual camera.

The above method may provide only the sensing information of the device and the position information of the camera to render the AR video of the 3D object content, thereby improving a rendering speed and reducing the delay factors.

However, the delay factors may occur depending on the communication environment between the device and the cloud and the performance of the device even in the encoding and decoding process of the device, and all delay factors may not be reduced by the methods.

Hereinafter, a system for providing video-based AR content will be described with reference to the accompanying drawings.

The embodiments of the present disclosure are provided to more fully describe the present disclosure to those skilled in the art, and the embodiments described below may be modified in various other forms, and the scope of the present disclosure is not limited to the following embodiments. Rather, these embodiments are provided to further enrich and perfect the present disclosure and to completely convey the spirit of the present disclosure to those skilled in the art.

The terms used herein are used to describe specific embodiments and are not intended to limit the present disclosure. As used herein, the singular forms may include plural forms unless they clearly indicate otherwise. Further, the terms “comprise” and/or “comprising” when used in the specification specify the presence of stated shapes, numbers, steps, operations, members, elements and/or groups thereof, and do not preclude the presence or addition of one or more other shapes, numbers, operations, members, elements and/or groups. As used herein, the term “and/or” includes any and all combinations of the listed items.

Although the terms first, second, etc. are used herein to describe various members, regions, and/or portions, it is apparent that these members, components, regions, layers, and/or portions are not limited by these terms. These terms do not imply a particular order, up or down, or superiority, and are used only to distinguish one member, region or portion from another member, region or portion. Accordingly, a first member, region, or portion to be described below may refer to a second member, region, or portion without departing from the teachings of the present disclosure.

Hereinafter, embodiments of the present disclosure will be described with reference to the accompanying drawings schematically illustrating embodiments of the present disclosure. In the drawings, for example, variations in the shapes depicted may be expected depending on manufacturing technology and/or tolerance. Therefore, an embodiment of the present disclosure should not be construed as being limited to a specific shape of a region shown herein, and should include, for example, a change in shape caused by manufacturing.

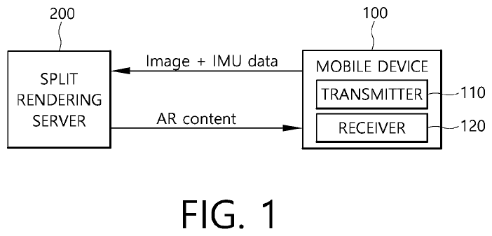

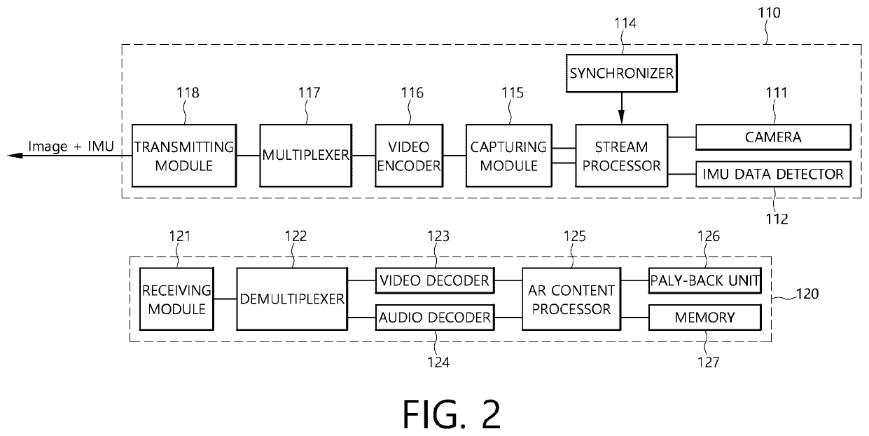

FIG. 1 is a block diagram of a system for providing video-based AR content according to the present disclosure, and FIG. 2 is a detailed block diagram of a mobile device in FIG. 1.

Referring to FIGS. 1 and 2, the present disclosure includes a mobile device 100 configured to transmit an image captured by a camera 111 and an IMU data, which is position and posture information about the camera 111, wherein the image and the IMU data are transmitted by being packaged into a single image, and play back of storing the received AR content, and a split rendering server 200 configured to render the packaged image of the mobile device 100 to provide the AR content.

The mobile device 100 includes a transmitter 110 for transmitting the image and IMU data to the split rendering server 200 and a receiver 120 for receiving and processing the AR content.

Hereinafter, the configuration and operation of the system for providing video-based AR content according to a preferred embodiment of the present disclosure configured as described above will be described in more detail.

First, the mobile device 100 accesses the split rendering server 200, and acquires the authority to use the service provided by the split rendering server 200. The service use authority may use a known login method or various authentication methods.

The mobile device 100 may be, for example, a smartphone, and preferably, an AR player.

The present disclosure is not limited to the type of the mobile device 100, and is not limited to the type of the mobile device 100 as long as it is capable of performing the functions described below.

The mobile device 100 acquires an image by using the camera 111 of the transmitter 110.

At this time, an IMU data detector 112 acquires data on the position and pose of the camera 111. Substantially, the data detected by the IMU data detector 112 may be data on the position and pose of the mobile device 100.

The IMU data detector 112 may be at least one of a gyrometer, an accelerometer, a geomagnetometer, and an altimeter included in the mobile device 100.

The image captured by the camera 111 and the position and pose data detected by the IMU data detector 112 are processed by a stream processor 113 as continuous stream data in accordance with the time synchronization of a synchronizer 114.

Next, the stream data is input to a capturing module 115, and the capturing module 115 is configured to package the image stream data and the IMU stream data into a single image, which is then packaged in five frames based on the image data.

In this case, the packaging refers to forming a data packet including a header, and packaging the image track in units of 5 frames. By restricting the packaging of the image track as described above, it is possible to minimize the occurrence of delay elements.

In addition, the present disclosure includes the image data and IMU data in the image track, thereby enabling efficient communication compared to a conventional method of transmitting the image and the IMU data separately.

The packaging format may use ISO/IEC 23000.

Next, the packaged image track is encoded through the video encoder 116.

In other words, the image data and the IMU data may be encoded together by using the video encoder 116.

Next, the encoded image track is selected by using a multiplexer 117, and the encoded image track is transmitted to the split rendering server 200 by using a transmitting module 118. The transmitting module 118 uses the HTTP QUIC as a communication protocol.

The split rendering server 200 decodes the received image track and performs rendering.

The performing rendering means rendering the selected 3D object content using the received image as a background, at this time, the 3D object content are rendered by converting the position and posture information of the 3D object using IMU data.

At this time, the performing the rendering of the 3D object content on the received image is to reduce the occurrence of rendering errors, and AR content including the 3D object content and mapping data is provided thereafter, so that when the 3D object is displayed together with the image captured by the camera 111, AR content that matches the actual environment may be provided.

In addition, the occurrence of dynamic errors due to changes in a user's gaze, i.e., changes in the position and posture of the mobile device 100, may be reduced by using the received IMU data.

In other words, by implementing and providing the 3D object in a direction corresponding to the IMU data, it is possible to display the 3D object in accurate form according to the user's gaze when viewing the AR content using the mobile device 100.

The split rendering server 200 performs rendering using the received image and the IMU data split by five frames and transmits the split AR content data to the mobile device 100 by splitting the same again.

At this time, the AR content data transmitted to the mobile device 100 is assumed to include AR content data in a unit of one frame in one track.

The delay rate may be minimized regardless of the communication environment and decoding performance of the mobile device 100.

The AR content data is received by the receiver 120 of the mobile device 100, and the content may be played back in a play-back 126 or stored in a memory 127 as needed.

The play-back 126 may include a display and an audio output device. At this time, the audio may be provided from the split rendering server 200 or may be audio provided from the mobile device 100 to the split rendering server 200.

More specifically, the AR content data including the mapping data, the video and the audio is received by a receiving module 121, and the video data and the audio data are split by a demultiplexer 122 and decoded by a video decoder 123 and an audio decoder 124, respectively.

At this time, as described above, only an image of one frame is included in the track and thus may be decoded by the video decoder 123 in real time.

An AR content processor 125 stores the decoded video and audio data in the memory 127 according to a setting, or enables it to be played back through the play-back 126.

The above play-back 126 includes a display and audio play-back device, and displays the received 3D object along with the image captured by the camera 111.

As described above, the present disclosure integrates data transmitted from the mobile device 100 to the split rendering server 200, but prevents the occurrence of delay elements by limiting the number of frames, and also prevents delay in displaying AR content by limiting the number of frames so that real-time decoding and playback are performed.

The present disclosure is not limited to the above embodiments and may be modified and modified in various ways without departing from the technical spirit of the present disclosure.

The present disclosure is intended to prevent a display delay of AR content by utilizing natural laws, and thus has industrial applicability.

What is claimed is:

1. A system comprising:
a mobile device including:
a transmitter configured to transmit an image captured by a camera and an inertial measurement unit (IMU) data corresponding to position and posture information via the camera, the transmitter further configured to combine the image and IMU data into a single image data packet prior to transmission, and
a receiver configured to receive and play back an augmented reality (AR) content at least; and
a split rendering server configured to render a three-dimensional object using the image and the IMU data of the image data packet of the mobile device, and provide the AR content, which is the rendered result, to the mobile device.

2. The system of claim 1, wherein the image data packet is configured to be packaged in units of five image frames.

3. The system of claim 1, wherein the image data packet is configured to be packaged in a packaging format of the ISO/IEC 23000 standard (ISO/IEC stands for International Organization for Standardization/International Electrotechnical Commission).

4. The system of claim 1, wherein the image data packet is configured to be transmitted according to an HTTP QUIC protocol (HTTP stands for hypertext transfer protocol and QUIC stands for quick UDP (user datagram protocol) internet connection).

5. The system of claim 1, wherein the AR content is configured to include one frame in one image track.

6. The system of claim 1, wherein the transmitter includes:
the camera configured to capture the image;
an IMU data detector configured to detect the IMU data;
a stream processor configured to convert the image and the IMU data into a stream data in accordance with synchronization; and
a capturing module configured to split the stream data into five frames and package the image and the IMU data into the single image data packet.

7. The system of claim 6, wherein the receiver includes:
an AR content processor configured to play back or store the AR content according to a setting;
a play-back configured to play back the AR content; and
a memory configured to store the AR content.
